(19) United States
(12) Patent Application Publication
(10) Pub. No.: US 2009/0009482 A1
(43) Pub. Date: Jan. 8, 2009

(54) TOUCH SENSOR PAD USER INPUT DEVICE

(76) Inventor: William J. McDermid, Niwot, CO (US)

Correspondence Address: DUFT BORNSEN & FISHMAN, LLP, 1526 SPRUCE STREET, SUITE 302, BOULDER, CO, 80302, US

(21) Appl. No.: 12/112,392

(22) Filed: Apr. 30, 2008

Related U.S. Application Data
(60) Provisional application No. 60/915,338, filed on May 1, 2007.

(51) Int. Cl. G06F 3/041

(52) U.S. Cl. 345/173

(57) ABSTRACT

A touch sensor pad may be utilized with an electronic device to perform different types of user input functions, such as typing, drawing, moving a cursor, etc. Regions of the touch sensor pad may correspond to keys of a keyboard. A user establishes a home position at a desired location of the touch sensor pad. When a user subsequently touches the touch sensor pad, the touch sensor pad determines a relative position of the touch in reference to the home position, and determines the value of the user input or keystroke based on the relative position. The value of the user input or the keystroke may then be processed by the controller.

### CROSS REFERENCE TO RELATED APPLICATIONS

This non-provisional application claims priority to U.S. provisional application 60/915,338 filed on May 1, 2007, which is incorporated herein by reference.

This application is related to U.S. Provisional Patent Application Ser. No. 60/913,972, filed Apr. 25, 2007 and entitled “METHOD AND APPARATUS FOR DETERMINING COORDINATES OF SIMULTANEOUS TOUCHES ON A TOUCH SENSOR PAD”, which is hereby incorporated by reference.

### BACKGROUND OF THE INVENTION

1. Field of the Invention

This invention relates to user input devices, and in particular, to touch sensor user input devices for an electronic device.

2. Statement of the Problem

User input devices are used with many types of electronic devices to input data and commands to the electronic devices. Different types of user input devices are needed for entering different types of data. For example, keyboards are used to enter characters, numbers, etc. Mice, trackballs, etc., are used for manipulating cursors, manipulating graphical user interfaces (GUIs), and scrolling. Typically, keyboards and other user input devices are implemented as mechanical devices incorporated into or used in conjunction with electronic devices. To switch from one user input device to another, the user may need to remove their hand from the first user input device to utilize the other user input device.

Also, each user input device utilizes surface space and/or volume of the electronic device and may only perform a single type of input function. Thus, an electronic device may need to incorporate several user input devices to allow a user to perform different types of input functions. This can be a problem, because placing several user input devices on a surface of an electronic device may increase the size of the electronic device. Further, user input devices typically are disposed on the same surface as a display of the electronic device. This is because some users may have difficulty inputting information into the electronic device if they are unable to see the display and the user input device at the same time. Many users type using a hunt and peck method, and need to see the location of their fingers on a keyboard in order to correctly type information into the electronic device. If a small electronic device is desired, a tradeoff is made between the size of the display and the size of the user input device to limit the overall size of the electronic device. As a result, both the display and the user input device may be relatively small in order to limit the overall size of the electronic device. Many users may find both the display and the user input device difficult or inconvenient to use due to the relatively small size of both components.

Further, the utilization of mechanical user input devices may require the physical location and orientation of the user input device to be fixed with respect to the electronic device. Further, in the case of mechanical keyboards and keypads, each key has a fixed size and placement on the keyboard. As a result, input of information may be inconvenient for some users because of the fixed size of the keys. For example, the keys may not be large enough for some users, or may be spaced too close together such that the user inadvertently strikes several keys at once. Further, the fixed position of a keyboard requires users to adjust the position of their hands to fit over the keys, rather than the positions of the keys adjusting to the positions of the hands of the user. This may cause stress to the hands of the user, and makes the user input process uncomfortable.

User input on handheld or portable devices is also difficult, because the user may need to hold the device in one hand, while typing with their other hand. As a result, the user may only be able to perform user input, such as typing, using a single hand. This is further exacerbated if the user needs a free hand to perform another task unrelated to the electronic device.

Thus, it is evident from the above discussed problems that improved solutions are needed for capturing user input for electronic devices.

### SUMMARY OF THE SOLUTION

The present invention overcomes the above described and other related problems with touch sensor pad user input devices. A touch sensor pad may be utilized with an electronic device to perform different types of user input functions. For example, a user may type, draw, move a cursor, etc., without removing their hands from the touch sensor pad. Advantageously, an electronic device may utilize the touch sensor pad to replace the functionality of several user input devices.

Regions of a touch sensor pad may correspond to keys of a keyboard (e.g., a QWERTY keyboard). A user establishes home positions of their fingers by placing their fingers at desired locations of the touch sensor pad. Subsequent keystrokes are determined relative to the home positions of the fingers, rather the requiring a user to strike specific coordinates of the touch sensor pad for a particular key. When a user subsequently touches the touch sensor pad, the touch sensor pad determines a relative position of the finger in reference to the home position, and determines the value of the keystroke based on the relative position. The value of the keystroke may then be processed by the electronic device.

In one embodiment of the invention, a user input device comprises an interface coupled to a touch sensor pad, and a controller. The controller determines a home position on the touch sensor pad responsive to a user applying a first pressure to the touch sensor pad. Subsequently, a user applies a second pressure to the touch sensor pad for a keystroke, and the controller detects the keystroke on the touch sensor pad. Responsive to detecting the keystroke, the controller determines a relative position of the keystroke in reference to the home position, and determines a value of the keystroke based on the relative position.

Another embodiment of the invention comprises an electronic device including a touch sensor pad on a first surface of the electronic device and a display on a second surface of the electronic device. Locations of a portion of the display may correspond to coordinates on the touch sensor pad. The electronic device further comprises a controller which determines an input location of user input on the touch sensor pad responsive to fingers of a user touching the touch sensor pad, and displays the location of the user inputs on the display.

Another embodiment of the invention comprises an electronic device including a touch sensor pad on a first surface of the electronic device and a display on an opposing second surface of the electronic device. Locations of a portion of the display may correspond to coordinates on the touch sensor pad. The electronic device further comprises a controller, which determines a home position on the touch sensor pad of fingers applying a first pressure to the touch sensor pad at a home position of the fingers, and displays the location of the user inputs on the display. The controller further detects a touch by a finger at an input location of the touch sensor pad, and determines a relative position of the touch in reference to the home position of the fingers. The controller determines user input corresponding to the touch based on the relative position, and measures a second pressure applied by a finger to the touch sensor pad responsive to the touch. If the second pressure exceeds a predetermined value, then the controller processes the user input and displays the location of the user input on the display.

In another embodiment of the invention, the user may grip the electronic device between their hands while placing their fingers on the touch sensor pad applying a first pressure to the touch sensor pad. Portions of the touch sensor pad may correspond to a keyboard of the electronic device. The controller determines home positions on the touch sensor pad of the user's fingers based on the locations where the user is initially gripping the electronic device. Responsive to detecting a keystroke by a finger at an input location of the touch sensor pad, the controller determines a relative position of the keystroke in reference to the home positions of the fingers, and determines a value of the keystroke based on the relative position. The controller also measures a second pressure applied by the finger to the touch sensor pad at the input location. If the second pressure exceeds a predetermined value, then the controller processes the value of the keystroke.

In another embodiment of the invention, the controller may display a keyboard pattern to the user, which indicates the location of the user's fingers on the touch sensor pad. As the user moves their fingers across the touch sensor pad, the controller displays visual cues on the keyboard pattern indicating particular keys corresponding to the location of the user's finger on the touch sensor pad. A first visual cue may indicate that a keystroke was processed if a pressure of the keystroke exceeds the predetermined value. A second visual cue may indicate to the user the present location of their finger if the pressure of the keystroke does not exceed the predetermined value, but the keystroke may not be processed.

In another embodiment of the invention, the controller may adjust the spacing and the positions of the keys based on the home positions of the fingers of the user.

A touch sensor pad utilized in accordance with one embodiment of the invention includes a first plurality of resistive sensor strips on a first resistive sheet and a second plurality of resistive sensor strips on a second resistive sheet. The strips of each sheet are oriented to form a grid on the touch sensor pad. A user may touch the touch sensor pad at multiple locations simultaneously. A controller of the touch sensor pad determines coordinates of each of the multiple locations of touch independently of other touches. To determine coordinates for a touch, the controller identifies a first strip of the first plurality of resistive sensor strips of the first resistive sheet and a second strip of the second plurality of resistive sensor strips of the second resistive sheet that are in physical contact responsive to the touch.

Responsive to the touch, the first strip makes physical contact with the second strip, and when the first strip is energized, it applies a first voltage to the second strip of the second resistive sheet. The controller measures the first voltage from the second strip and determines a coordinate of the touch in one dimension (e.g., a y-dimension). When the second strip is energized, it applies a second voltage to the first strip of the first resistive sheet. The controller measures the second voltage from the first strip and determines a coordinate of the touch in another dimension (e.g., an x-dimension).

Further, the controller may determine an area of contact or a pressure of contact of a touch based on a resistance change of the first or the second strip responsive to the touch. A strip has a base resistance per unit length. As two strips come in contact responsive to a touch, a measured resistance of a strip will change based on the area of contact between the strips. The difference between the measured resistance and the base resistance of the strip may be correlated to an area of contact of the touch, or a pressure of contact of the touch.

The invention may include other exemplary embodiments described below.

### DESCRIPTION OF THE DRAWINGS

The above and other advantages and features of the invention may be better understood from a reading of the detailed description taken in conjunction with the drawings in which the same reference number represents the same element or similar type of element on all drawings.

FIG. 1 illustrates an electronic device in an exemplary embodiment of the invention.

FIG. 2 illustrates a close up view of the touch sensor pad of FIG. 1 in an exemplary embodiment of the invention.

FIG. 3 illustrates the touch sensor pad of FIG. 1 embodied as a QWERTY keyboard in an exemplary embodiment of the invention.

FIG. 4 illustrates a touch sensor pad in an exemplary embodiment of the invention.

FIG. 5 illustrates a close up view of the controller of FIG. 4 in an exemplary embodiment of the invention.

FIG. 6 illustrates a top view of the touch sensor pad of FIG. 4 in an exemplary embodiment of the invention.

FIG. 7 illustrates a top view of the second resistive sheet of FIG. 4 in an exemplary embodiment of the invention.

FIG. 8 illustrates a top view of the first resistive sheet of FIG. 4 in an exemplary embodiment of the invention.

FIG. 9 illustrates a flow chart of a method for determining coordinates of simultaneous touches on the touch sensor pad of FIG. 4 in an exemplary embodiment of the invention.

FIG. 10 illustrates a top view of the touch sensor pad of FIG. 4 in an exemplary embodiment of the invention.

FIG. 11 illustrates a top view of a first resistive sheet of the touch sensor pad of FIG. 10 in an exemplary embodiment of the invention.

FIG. 12 illustrates a top view of a second resistive sheet of the touch sensor pad of FIG. 10 in an exemplary embodiment of the invention.

FIG. 13 illustrates a method for determining an area of contact or a pressure of contact of a touch by an object contacting a touch sensor pad in an exemplary embodiment of the invention.

FIG. 14 illustrates a method for determining an input of a touch sensor pad in an exemplary embodiment of the invention.

FIG. 15 illustrates a home position of a user's fingers on the touch sensor pad of FIG. 1 in an exemplary embodiment of the invention.

FIG. 16 illustrates a position of a user's fingers while applying a keystroke to the touch sensor pad of FIG. 1 in an exemplary embodiment of the invention.

FIG. 17 illustrates a method for determining an input of a touch sensor pad in an exemplary embodiment of the invention.

FIGS. 18-20 illustrate a touch sensor pad embodied as a mobile telephone keypad in an exemplary embodiment of the invention.

FIG. 21 illustrates a method for determining the spacing and position of the keys of the touch sensor pad of FIG. 1 in an exemplary embodiment of the invention.

FIG. 22 illustrates a method for determining user input to an electronic device in an exemplary embodiment of the invention.

FIG. 23 illustrates an electronic device incorporating the touch sensor pad of FIG. 1 on a back surface of the electronic device in an exemplary embodiment of the invention.

FIG. 24 illustrates the electronic device of FIG. 23 incorporating a display on a front surface of the electronic device in an exemplary embodiment of the invention.

FIG. 25 illustrates a method for determining an action to perform for a keystroke based on a pressure applied to the touch sensor pad of FIG. 1 by the keystroke in an exemplary embodiment of the invention.

FIG. 26 illustrates a method for providing visual cues to a user regarding a location of a keystroke based on a pressure applied by the touch to the touch sensor pad of FIG. 1 in an exemplary embodiment of the invention.

FIG. 27 illustrates a method for incorporating a touch sensor keyboard on a back surface of an electronic device in an exemplary embodiment of the invention.

FIG. 28 illustrates a front surface of an electronic device in an exemplary embodiment of the invention.

FIG. 29 illustrates a back surface of the electronic device of FIG. 28 in an exemplary embodiment of the invention.

FIG. 30 illustrates the positions of the user's finger relative to keys displayed by the display of the electronic device of FIG. 28 in an exemplary embodiment of the invention.

### DETAILED DESCRIPTION OF THE INVENTION

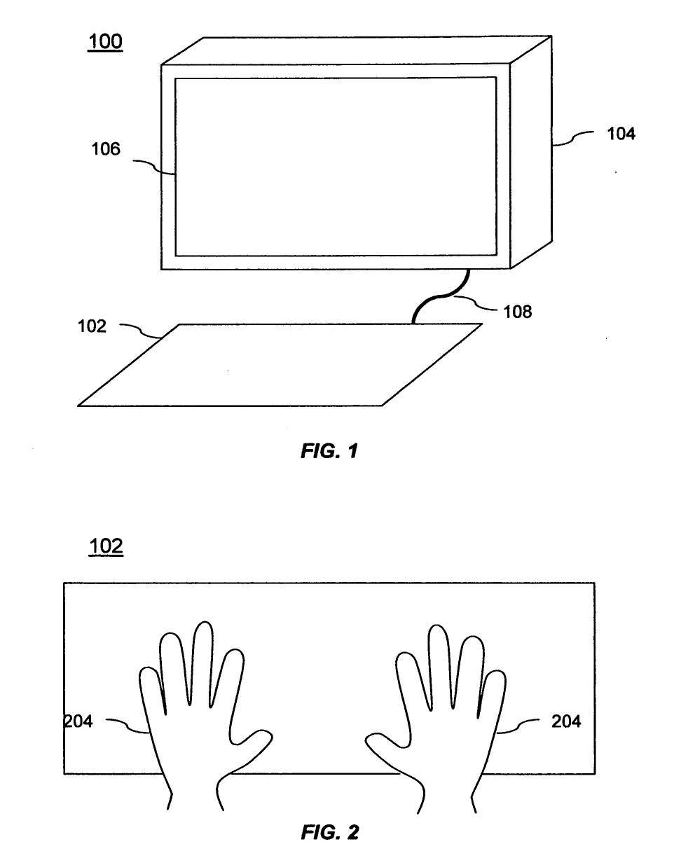

FIGS. 1-30 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an electronic device 100 in an exemplary embodiment of the invention. Electronic device 100 is illustrated embodied as a computer 104, including a display 106 and processing circuitry (not visible in FIG. 1). However, electronic device 100 may comprise any type of electronic or computing device including a user input device.

Electronic device 100 includes a touch sensor pad 102, which may be connected to computer 104 through a cable 108. Touch sensor pad 102 may also be wirelessly connected to computer 104, or may integrate onto a surface of computer 104. Touch sensor pad 102 and display 106 may be integrated to form a touch screen. Touch sensor pad 102 is adapted to determine coordinates of one or more touch points along the surface of touch sensor pad 102, and capture input applied to touch sensor pad 102 by a user based on the coordinates of the touch points.

Referring to FIG. 2, a user (not visible in FIG. 2) places their hands 204 on the surface of touch sensor pad 102. As hands 204 make contact with touch sensor pad 102, coordinates of the touch points are determined and correlated to input applied by the user. For example, input may include keystrokes on a QWERTY keyboard.

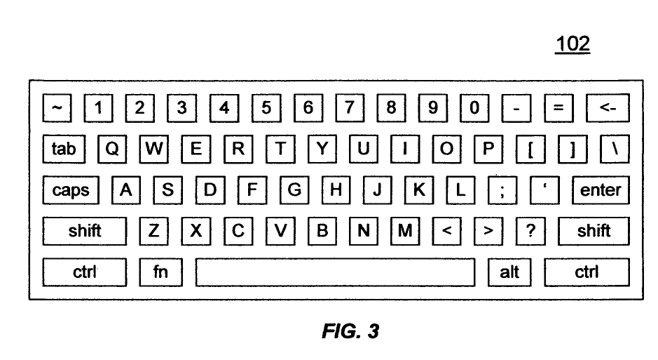

FIG. 3 illustrates touch sensor pad 102 embodied as a QWERTY keyboard in an exemplary embodiment of the invention. Regions of touch sensor pad 102 may correspond to keys of the QWERTY keyboard. However, these regions are not fixed. Rather, the regions of touch sensor pad 102 corresponding to each key of the keyboard are determined based on a relative position of a finger with respect to an associated home position of the finger. Thus, specific regions and coordinates of touch sensor pad 102 may not be allocated to a specific key, but rather, keystrokes are determined based on relative positions of the user's fingers, as subsequently described. Further, the home position may change each time a user utilizes touch sensor pad 102.

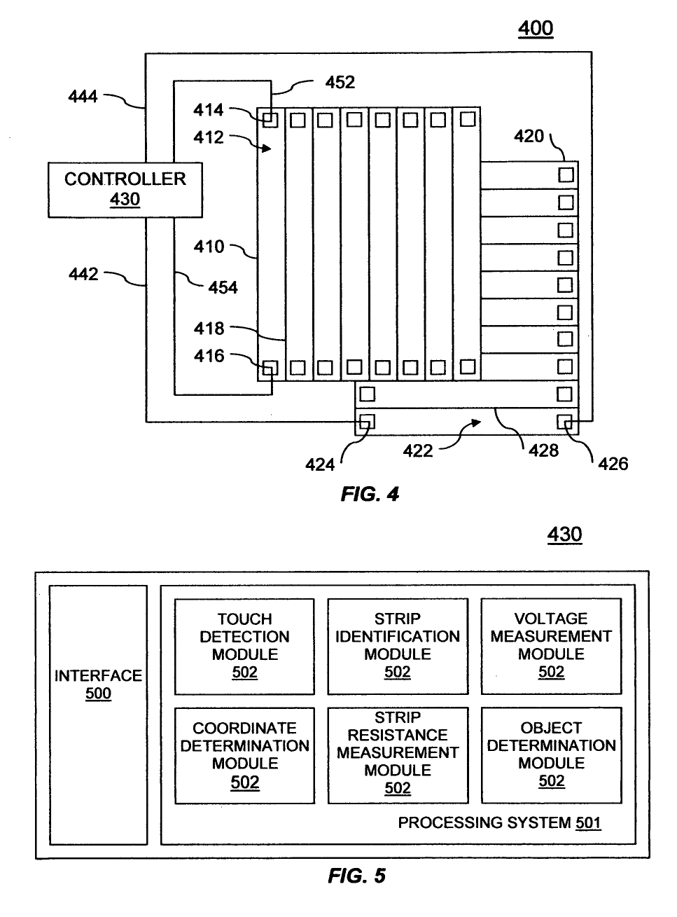

FIG. 4 illustrates a touch sensor pad 400 in an exemplary embodiment of the invention. Touch sensor pad 400 includes a first resistive sheet 410 and a second resistive sheet 420. First resistive sheet 410 may comprise a clear, flexible insulator sheet with a linear resistive coating on one side (e.g., Indium Tin Oxide). The resistive coating may comprise a plurality of strips (e.g., strip 412) running a length of first resistive sheet 410. Each strip is separated from other strips of the resistive coating by an insulator strip (e.g., insulator 418 which separates strip 412 from an adjacent strip). Each strip further comprises terminals on each end of the strip (e.g., terminal 414 and terminal 416 of strip 412).

Second resistive sheet 420 is constructed in a similar manner. The resistive coating side of first resistive sheet 410 is disposed facing the resistive coating side of second resistive sheet 420. There may be a plurality of strips (e.g., strip 422) running a length of second resistive sheet 420. The strips of second resistive sheet 420 are separated from other strips of the resistive coating by an insulator strip (e.g., insulator 428 which separates strip 422 from an adjacent strip). Each strip further comprises terminals on each end of the strip (e.g., terminal 424 and terminal 426 of strip 422).

The strips of second resistive sheet 420 are disposed in a direction perpendicular to strips of first resistive sheet 410 when both sheets are facing one another. The strips of first resistive sheet 410 and second resistive sheet 420 form a matrix or grid of touch sensor regions of touch sensor pad 400, with the intersection of a strip of first resistive sheet 410 and a strip of second resistive sheet 420 forming a single region of the grid. First resistive sheet 410 and second resistive sheet 420 may be separated by regularly spaced insulator dots (not shown) which keep the sheets apart at rest. When a user touches touch sensor pad 400, one or more strips of first resistive sheet 410 will come in contact with one or more strips of second resistive sheet 420, allowing a controller 430 to measure attributes (e.g., a voltage or resistance) of the strips to determine information regarding the touch point.

Controller 430 is connected to terminals 414 and 416 of strip 412 of first resistive sheet 410 using wires 452 and 454. Controller 430 may connect to pairs of terminals for other strips of first resistive sheet 410 using additional pairs of wires. Terminals 424 and 426 of strip 422 of second resistive sheet 420 are connected to controller 430 through wires 442 and 444. Likewise, controller 430 may connect to other terminals of other strips of second resistive sheet 420 using additional pairs of wires. First resistive sheet 410 and second resistive sheet 420 may comprise any number of strips across their surfaces, and the strips may be of any size according to desired design criteria of touch sensor pad 400. Each pair of wires for a terminal may be connected to switches, multiplexers, etc., to control signals between controller 430 and the terminals. For example, a switch may control applying a voltage to the terminals to energize the strip. A multiplexer may control whether the strip is energized, used for sensing, inactive, etc.

FIG. 5 illustrates a close up view of controller 430 of FIG. 4 in an exemplary embodiment of the invention. Controller 430 comprises an interface 500 coupled to strips of first resistive sheet 410 and coupled to strips of second resistive sheet 420. Using interface 500, controller 430 may energize strips of first resistive sheet 410 and strips of second resistive sheet 420, as well as measure attributes of the strips, including voltages, resistances, etc. Interface 500 may comprise switches (not shown), multiplexers (not shown), and other similar components used to energize and/or measure values of the strips of first resistive sheet 410 and the strips of second resistive sheet 420.

Controller 430 may also comprise processing system 501. Processing system 501 may comprise touch detection module 502, which is adapted to determine touches by objects on touch sensor pad 400. Processing system 501 may also comprise strip identification module 504, which is adapted to identify strips of first resistive sheet 410 and second resistive sheet 420 which may be in physical contact with each other responsive to a touch point on touch sensor pad 400.

Processing system 501 may further comprise voltage measurement module 506, which is adapted to measure voltages of strips of first resistive sheet 410 and second resistive sheet 420. Coordinate determination module 508 of processing system 501 is adapted to determine coordinates of touches on touch sensor pad 400 based on voltages measured by voltage measurement module 506. Processing system 501 may further comprise strip resistance measurement module 510, which is adapted to measure resistances of strips of first resistive sheet 410 and/or second resistive sheet 420. Pressure determination module 512 of processing system 501 is adapted to utilize resistances measured by strip resistance measurement module 510 to determine the pressure of the touch contacting touch sensor pad 400.

Those of ordinary skill in the art will readily recognize that the various functional elements 500 through 512 shown as operable within controller 430 and processing system 501 may be combined into fewer discrete elements or may be broken up into a larger number of discrete functional elements as a matter of design choice. Thus, the particular functional decomposition suggested by FIG. 5 is intended merely as exemplary of one possible functional decomposition of elements within controller 430 and processing system 501. Further, touch sensor pad 400 and controller 430 may comprise additional elements not illustrated in FIGS. 4-5 for the sake of brevity. Subsequent figures will be discussed in reference to touch pad sensor 400 illustrated in FIGS. 4-5.

FIG. 6 illustrates a top view of touch sensor pad 400 of FIG. 4 in an exemplary embodiment of the invention. More specifically, FIG. 6 illustrates a matrix formed by the intersection of strips of first resistive sheet 410 oriented in one direction, and strips of second resistive sheet 420 (not visible in FIG. 5) oriented in another direction. The strips of second resistive sheet 420 are oriented perpendicular to the strips of first resistive sheet 410.

Coordinates of a touch may be determined by locating two intersecting strips making physical contact responsive to the touch point. Because first resistive sheet 410 of touch sensor pad 400 (see FIG. 4) is separated into a plurality of strips, each strip may be energized independently of other strips on the same surface. Each strip may then be searched independently of other strips to determine whether there is a touch along the surface of the strip. A touch along a strip of first resistive sheet 410 causes the strip while energized to transfer a voltage to the contacted strip of second resistive sheet 420. If there is no touch along the surface of a strip (e.g., strip 412) of first resistive sheet 410, then no increase in the voltage potential of second resistive sheet 420 will occur. However, if there is a touch along the surface of a strip of first resistive sheet 410, then the energized strip will apply a voltage to one or more strips of second resistive sheet 420. Thus, an increase in the voltage potential of second resistive sheet 420 may be measured. A similar process may be used to identify strips of second resistive sheet 420. This allows controller 430 to independently and accurately determine multiple touch points across the surface of touch sensor pad 400.

The following process may be used to determine whether there is a touch in one strip of first resistive sheet 410, and to further determine a coordinate of a touch point in a first dimension of touch sensor pad 400. Assume that a user touches touch sensor pad 400 at touch point 610 (see FIG. 6). Controller 430 energizes strip 412 of first resistive sheet 410 to check for touches, and the other strips of touch sensor pad 400 are left un-energized. Controller 430 applies a voltage gradient along strip 412 between terminals 414 and 416 (see FIG. 4). Second resistive sheet 420 may be attached to a pull down resistor (not shown), and left un-energized.

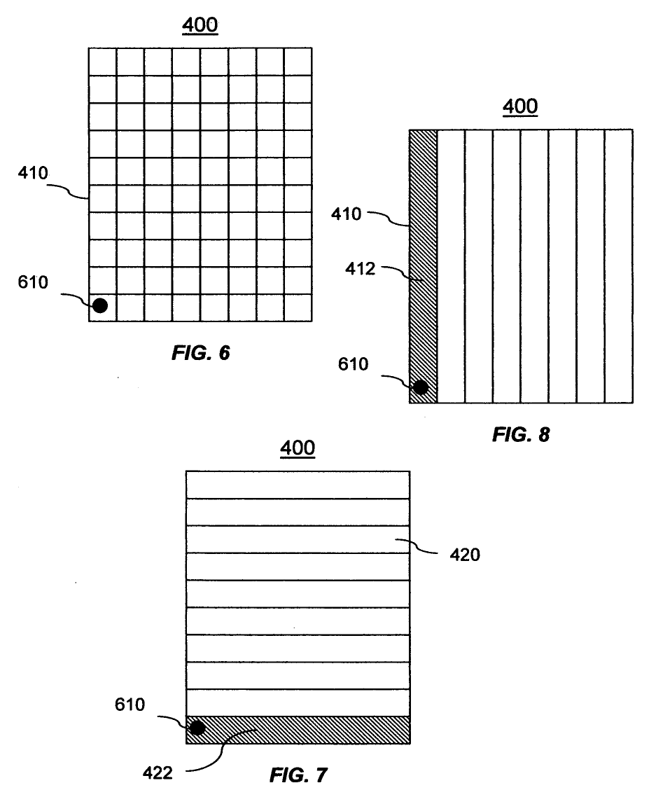

If a user touches touch sensor pad 400 along strip 412, then strip 412 will make physical contact with second resistive sheet 420. Touch point 610 has a corresponding voltage which is based on a position along the voltage gradient of strip 412. The voltage is applied to strip 422 of second resistive sheet 420, and the applied voltage overcomes the pull down resistor and raises the voltage potential of second resistive sheet 420. FIG. 7 illustrates a top view of second resistive sheet 420 of FIG. 4 in an exemplary embodiment of the invention. More specifically, FIG. 7 illustrates strip 422 of second resistive sheet 420 energized to a voltage applied by strip 412 (not visible in FIG. 7) of first resistive sheet 410 responsive to touch point 610 (see FIG. 5).

Controller 430 may measure the voltage of second resistive sheet 420 using terminals 424 and 426 (see FIG. 4). The measured voltage determines a coordinate in a first dimension (e.g., a y coordinate) of touch point 610. If there was no touch along strip 412, then controller 430 would determine that no voltage potential increase occurred in second resistive sheet 420, and thus, determine that there is no touch along strip 412.

The process may then be repeated on second resistive sheet 420 to determine coordinates of touches in a second dimension. For example, controller 430 may energize strip 422 between terminals 424 and 426 to set up a voltage gradient across second strip 422. First resistive sheet 410 may also be attached to a pull down resistor (not shown), and left un-energized. Because of touch point 610, strip 422 will make physical contact with and apply a voltage to first resistive sheet 410, which may be measured by controller 430 across terminals 414 and 416. FIG. 8 illustrates a top view of first resistive sheet 410 of FIG. 4 in an exemplary embodiment of the invention. More specifically, FIG. 8. illustrates strip 412 of first resistive sheet 410 energized to a voltage applied by strip 422 (not visible in FIG. 8) of second resistive sheet 420 responsive to touch point 610 (see FIG. 6).

The measured voltage determines a coordinate of touch point 610 in a second dimension (e.g., an x coordinate). This process may be repeated for additional strips along both first resistive sheet 410 and second resistive sheet 420 to determine multiple simultaneous touch points on touch sensor pad 400.

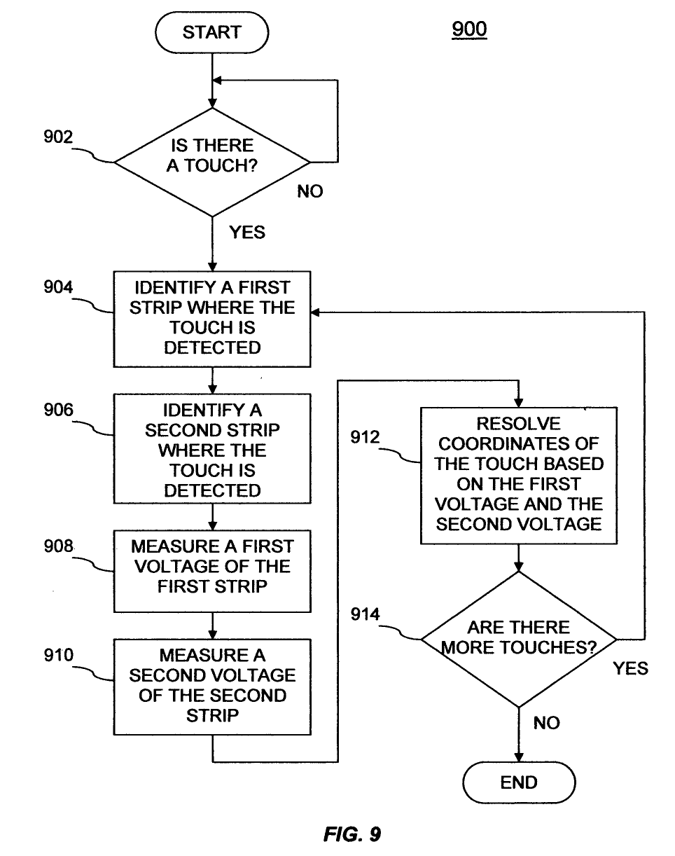

FIG. 9 illustrates a flow chart of a method 900 for determining coordinates of simultaneous touches on touch sensor pad 400 in an exemplary embodiment of the invention. The steps of method 900 will be discussed with respect to touch sensor pad 400 illustrated in FIGS. 6-8 and FIGS. 10-12. The steps of method 900 are not all inclusive, and may include other steps not shown for the sake of brevity.

In step 902, controller 430 determines whether there is a touch on touch sensor pad 400. To determine whether there is a touch on touch sensor pad 400, controller 430 may drive terminals of one end of all of the strips of first resistive sheet 410 to a positive voltage (V+), and leave the terminals at the other end of the strips floating so that no current will flow. Controller 430 connects the strips of second resistive sheet 420 to touch detection module 502 and activates a pull down resistor attached to second resistive sheet 420. If there is a touch on touch sensor pad 400, then the pulled down signal from second resistive sheet 420 will rise, signaling a touch. If a touch is detected, then controller 430 moves to step 904. Otherwise, controller 430 continues looping through step 902 until a touch is detected.

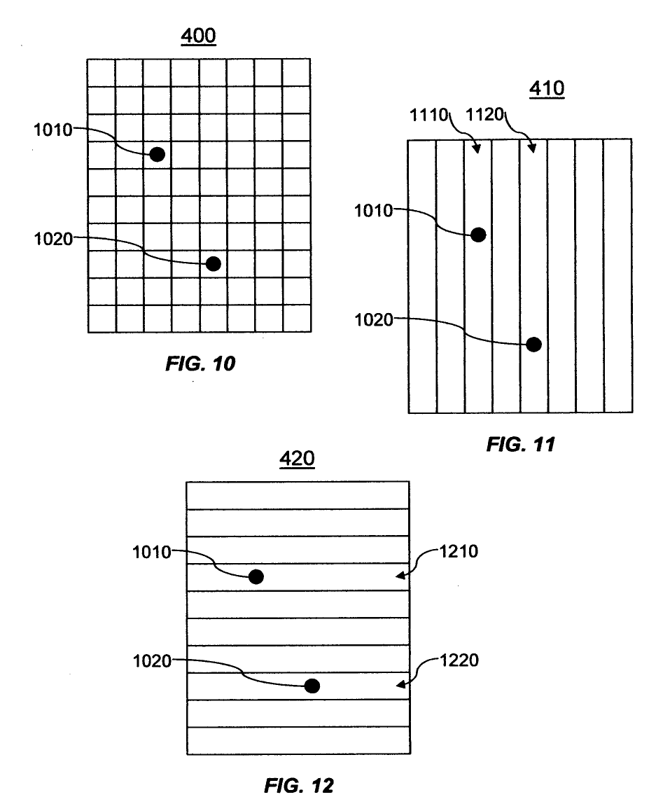

Assume that a user touches touch sensor pad 400 at two locations simultaneously. FIG. 10 illustrates a top view of touch sensor pad 400 of FIG. 4 in an exemplary embodiment of the invention. More specifically, FIG. 10 illustrates a touch point 1010 and a touch point 1020 on touch sensor pad 400.

FIG. 11 illustrates a top view of a first resistive sheet 410 of touch sensor pad 400 of FIG. 10 in an exemplary embodiment of the invention. FIG. 12 illustrates a top view of a second resistive sheet 420 of touch sensor pad 400 of FIG. 10 in an exemplary embodiment of the invention. Touch point 1010 of FIG. 10 will touch a first strip 1110 (see FIG. 11) on first resistive sheet 410, and a second strip 1210 (see FIG. 12) on second resistive sheet 420. Touch point 1020 of FIG. 9 will touch a third strip 1120 (see FIG. 11) on first resistive sheet 410, and a fourth strip 1220 (see FIG. 12) on second resistive sheet 420.

In step 904, strip identification module 504 of controller 430 identifies first strip 1110 of first resistive sheet 410 that is physically contacting second strip 1210 of second resistive sheet 420 responsive to touch point 1010 contacting touch sensor pad 400. Strip identification module 504 may conduct a parallel search of the strips of first resistive sheet 410, may step through each strip of first resistive sheet 410 individually, or may use other searching techniques to identify first strip 1110 corresponding to touch point 1010. Strips of first resistive sheet 410 may be energized individually or in groups to identify first strip 1110, and strip identification module 504 may determine whether a voltage increase is detected on second resistive sheet 420. If there is a touch point along an energized strip, then the energized strip will apply a voltage to second resistive sheet 420 and cause a voltage increase in second resistive sheet 420. If a voltage increase is detected on second resistive sheet 420, then first strip 1110 may be identified by strip identification module 504, or in the case of group searching, the search may be further narrowed.

In step 906, strip identification module 504 of controller 430 identifies second strip 1210 of second resistive sheet 420. Strip identification module 504 may conduct a parallel search of the strips of second resistive sheet 420, may step through each strip of second resistive sheet 420 individually, or may use other searching techniques to identify second strip 1210 where touch point 1010 contacts touch sensor pad 400. Strips of second resistive sheet 420 may be energized individually or in groups to identify second strip 1210, and strip identification module 504 may determine whether a voltage increase is detected on first strip 1110 of first resistive sheet 410. If there is a touch point along an energized strip, then the energized strip will apply a voltage to first strip 1110 (and possibly other strips) and cause a voltage increase. If a voltage increase is detected on first strip 1110, then second strip 1210 may be identified by strip identification module 504, or in the case of group searches, the search may be further narrowed.

In step 908, voltage measurement module 506 of controller 430 measures a first voltage of second strip 1210 applied by first strip 1110 while the strips are in contact responsive to touch point 1010. The first voltage may be measured by applying a voltage gradient between the terminals (not visible in FIG. 11) of first strip 1110, and measuring the voltage of second strip 1210. The first voltage may be correlated to a coordinate of touch point 1010 in a second dimension (e.g., a y-coordinate).

In step 910, voltage measurement module 506 of controller 430 measures a second voltage of first strip 1110 applied by second strip 1210 while the strips are in contact responsive to touch point 1010. The second voltage may be measured by applying a voltage gradient between the terminals (not visible in FIG. 12) of second strip 1210, and measuring the voltage of second strip 1210. The first voltage may be correlated to a coordinate of touch point 1010 in a first dimension (e.g., an x-coordinate).

In step 912, coordinate determination module 508 of controller 430 determines coordinates of touch point 1010 based on the first voltage and the second voltage. In step 914, touch detection module 502 determines whether there are more touches on touch sensor pad 400. If there are no additional touches on touch sensor pad 400, then processing by controller 430 ends. Otherwise, processing by controller 430 loops back to step 904 to determine coordinates for a second touch point 1020. Controller 430 may identify third strip 1120 and fourth strip 1220 and measured associated voltages of the strips. From this information, coordinate determination module 508 of controller 430 may determine coordinates of touch point 1020.

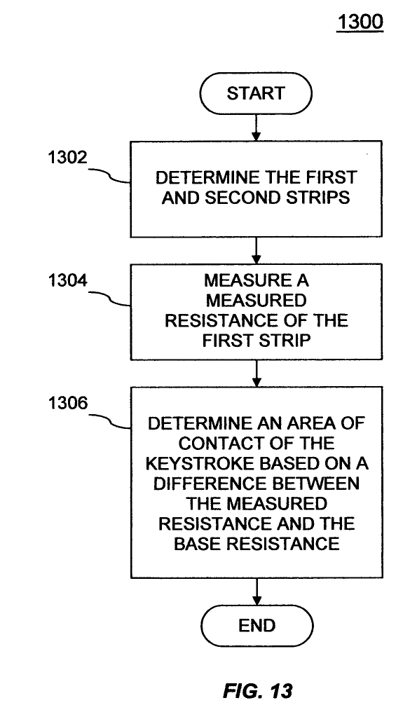

Touch sensor pad 400 of FIG. 4 may be utilized to determine an area or size of an object contacting touch sensor pad 400, or a pressure of an object applied to touch sensor pad 400 by the object. FIG. 13 illustrates a method 1300 for determining an area of contact of a touch or a pressure of contact of a touch by an object contacting a touch sensor pad in an exemplary embodiment of the invention. The steps of method 1300 are described in reference to touch sensor pad 400 illustrated in FIGS. 4-5. The steps of method 1300 are not all-inclusive, and may include other steps not shown for the sake of brevity.

In step 1302, strip identification module 504 of controller 430 determines a first strip of first resistive sheet 410 and a second strip of a second resistive sheet 420 corresponding to a touch on touch sensor pad 400. In step 1304, strip resistance measurement module 510 measures a measured resistance (Rm) of the first strip during contact between the first strip and the second strip responsive to the touch. The measured resistance is used to determine a resistance shift (Rs). The resistance shift (Rs) measures the affect on the overall resistance of a strip responsive to a touch (i.e., physical contact between the two strips).

Each strip has a resistance per unit length. For example, first resistive sheet 410 may have a resistance R1/unit length, and second resistive sheet 420 may have a resistance R2/unit length. Therefore, each strip has an overall resistance which is equal to (R/unit length)*(the total length of the strip), e.g., a base resistance (Rb). The physical contact between first resistive sheet 410 and second resistive sheet 420 forms two resistors in parallel over the area of a touch. Thus, the overall resistance of a strip on either of first resistive sheet 410 or second resistive sheet 420 during physical contact will be reduced by (R1*R2)/(R1+R2) multiplied by the length of the touch area, i.e., the

If both first resistive sheet 410 and second resistive sheet 420 have the same resistance per unit length, then the overall affect on the measured resistance of either sheet will be R/2 multiplied by the length of the touch area. However, if the resistance per unit length of one sheet (e.g., first resistive sheet 410) is relatively smaller than the resistance per unit length of the other sheet (e.g., second resistive sheet 420), then the percentage affect on the measured resistance of the sheet having the larger resistance per unit length will be relatively larger, and creates a larger resistance shift (Rs). Thus, the resistance may be measured from the strip having the larger resistance per unit length to more easily determine the resistance shift (Rs).

In step 1306, strip resistance measurement module 510 determines an area of contact of the touch based on a difference between the measured resistance (Rm) and the base resistance (Rb) of the first strip, i.e., the resistance shift (Rs) of the first strip responsive to the touch. Because the resistance shift corresponds to a resistance per unit length, the value may be used to determine a length of contact along the strip, and thus be correlated to an area of contact of the touch along the first strip.

When first resistive sheet 410 and second resistive sheet 420 make physical contact, the contact area will be greater if the object causing the contact is larger. A larger area of contact correlates to a lower overall resistance of an energized strip (e.g., a larger resistance shift). Therefore, a relatively large object contacting touch sensor pad 400 will lower the overall resistance of a strip more than a relatively smaller object. Further, an object pressing harder on touch sensor pad 400 will create a larger area of contact, which may be used to determine a pressure of contact applied to touch sensor pad 400 by an object.

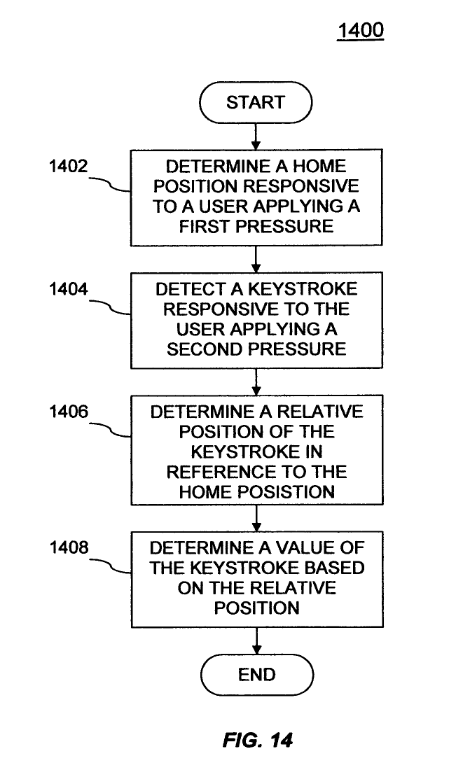

FIG. 14 illustrates a method 1400 for determining an input of a touch sensor pad in an exemplary embodiment of the invention. The steps of method 1400 are described in reference to electronic device 100 and touch sensor pad 102 illustrated in FIGS. 1-2 and. 4-5. The steps of method 1400 may not be all-inclusive, and may include other steps not shown for the sake of brevity.

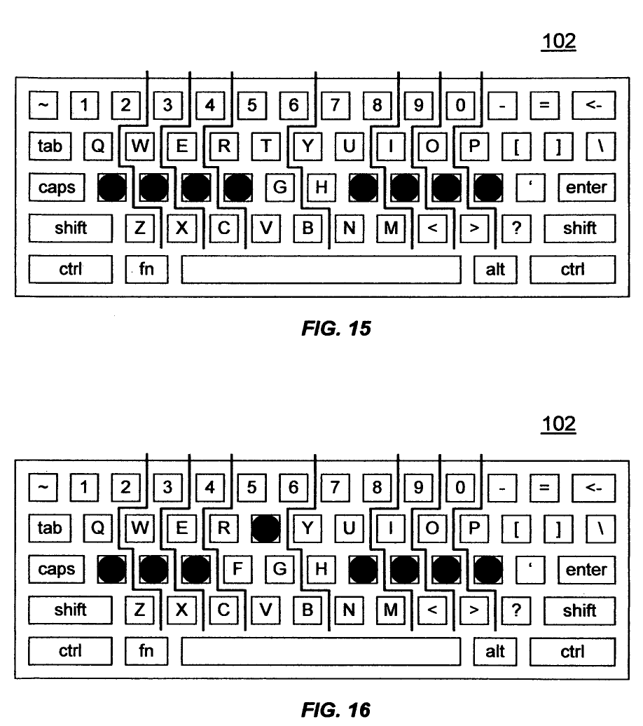

In step 1402, controller 430 determines a home position on touch sensor pad 102 responsive to a user applying a first pressure to touch sensor pad 102. The home position represents a base location from which the location of other touch points may be determined. For example, a user may initially rest their fingers on touch sensor pad 102, applying a first pressure at or below a resting threshold pressure. FIG. 15 illustrates the home position on touch sensor pad 102 of a user's fingers in an exemplary embodiment of the invention. The initial resting locations of the fingers may correspond to touch-typing home row keys.

Touch-typing is one technique that allows a user to place their fingers at rest in the middle of a keyboard while their fingers rest on certain keys, known as home keys. Normally, the user allows their eight fingers to rest above the keyboard without making contact with the keys. To enter a letter, the user reaches the appropriate key with their closest finger, and then returns the finger to its associated home key. Thus, each key is reachable by one finger using a specific direction of movement from the associated home key of the finger. The black dots illustrate the home key locations of the eight fingers of the user (e.g., the “A”, “S”, “D” and “F” keys for the left hand, and the “J”, “K”, “L” and “:” keys for the right hand). The solid lines illustrate the boundaries of each work zone while typing using the touch-typing technique. For example, the middle finger of the left hand is positioned initially on the “D” key, and may be used to reach the “4”, “E” and “X” keys.

While using touch sensor pad 102, the user may initially place their fingers in contact with touch sensor pad 102, rather than resting their fingers above the keys. The pressure applied by the user's fingers while at rest may be greater than a resting threshold pressure but less than a keystroke threshold pressure. Controller 430 may determine the initial coordinates of each finger, and correlate the initial coordinates of the fingers to positions of the home row keys. The initial coordinates and home position may be determined as described above in reference to FIGS. 8 and 12. The pressure may be detected and/or measured as described in reference to FIG. 13. Subsequent keystrokes and other user input may be determined relative to the home positions of the fingers.

In step 1404, controller 430 detects a keystroke on touch sensor pad 102 responsive to a user applying a second pressure to the touch sensor pad. As used herein, a keystroke is a touch by a user on touch sensor pad 400. The user may touch a location of touch sensor pad 400 with their finger or another object. The touch has coordinates, which may be determined as described above in reference to FIG. 8. The second pressure may greater than a keystroke threshold pressure defined by controller 530. The keystroke threshold pressure may be statically defined in controller 530, or may be determined based on the resting threshold pressure. Preferably, the keystroke threshold pressure is greater than the resting threshold pressure.

The keystroke may comprise the user moving a finger from one location of touch sensor pad 102 to another location (e.g., moving their middle finger from the “D” key to the “X” key), or may comprise the user pressing harder on touch sensor pad 102 (e.g., applying a second pressure) with a finger at the home position of the finger (e.g., the user pressing the “D” key). Thus, a keystroke of the “X” key may correspond to two strips which are different than the strips of the home position of the finger. However, a keystroke of the “D” key may correspond to two strips which are the same as the strips of the home position of the finger. Further, in some situations, one or both strips identified for a particular keystroke may be the same as the strips identified for the home position of the finger. This occurs if both locations sit along the same row or column of the grid formed by first resistive sheet 410 (see FIG. 4) and second resistive sheet 420.

In step 1406, controller 430 determines a relative position of the keystroke in reference to the home position responsive to detecting the keystroke. For example, assume that the user moves their index finger from its home position (e.g., the “F” key) to a position up and to the right of the home position (e.g., the “T” key) as illustrated in FIG. 16. Controller 430 determines relative coordinates of the index finger with respect to its associated home position.

In step 1408, controller 430 determines a value of the keystroke based on the relative position of the keystroke. For example, if the index finger moves up and to the right from its home position, then controller 430 may determine that the value of the keystroke is the letter “T”. Likewise, if the index finger moves in a direction to the right of the home position, then the value of the keystroke may be the letter “G”. This allows a user to move their finger in a general direction of a key, without having to strike the exact coordinates of a region of touch sensor pad 102 defined for the key.

Further, the user's fingers are not bound by the work zones defined by the touch-typing technique. Since the values of the keystrokes are defined relative to the home position of a finger, the user may move fingers outside the boundaries of the touch-typing work zones. Method 1400 may also be applied to any type of keyboard or keypad with any type of keyboard layout. The home position of a finger may be determined from any key selected based on desired design criteria. Thus, method 1400 is not limited to the touch-typing technique described above, or to keyboards or keypads requiring the use of multiple fingers or hands, as described below.

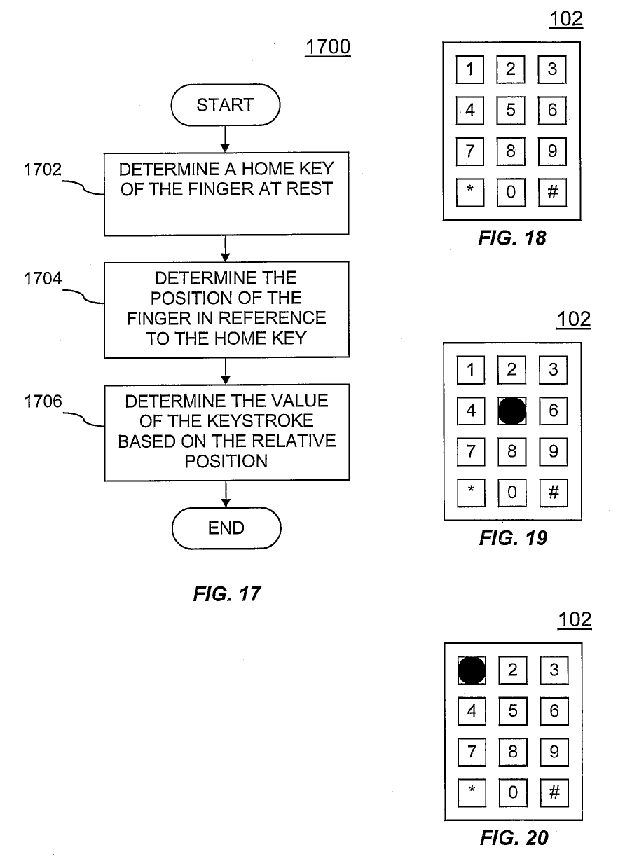

FIG. 17 illustrates a method 1700 for determining an input of a touch sensor pad in an exemplary embodiment of the invention. The steps of method 1700 are described in reference to electronic device 100 and touch sensor pad 102 illustrated in FIGS. 1-2, 4-5 and 18-20. The steps of method 1700 may not be all-inclusive, and may include other steps not shown for the sake of brevity.

In step 1702, controller 530 determines a home key of a finger of a user at rest. FIG. 18 illustrates touch sensor pad 102 embodied as a mobile telephone keypad in an exemplary embodiment of the invention. Relative positions of each key of the mobile telephone keypad may be determined in reference to a home key.

Assume for example, that the “5” key is selected as the home key of a finger at rest. A user initially places their finger (i.e., the black dot of FIG. 19) anywhere on touch sensor pad 102. The user may place their finger on top of touch sensor pad 102 responsive to a prompt by electronic device 100 (see FIG. 1). The initial coordinates of the finger are determined by controller 430, and that location establishes the position of the “5” key, and hence, the home key (see FIG. 19). All subsequent keystrokes may be determined relative to the position of the “5” key.

In step 1704, controller 530 determines a relative position of the finger in reference to the home key. Assume that the user moves their finger in a direction up and to the left from the home key (see FIG. 20). This relative position corresponds to a location of the “1” key. In step 1706, controller 530 determines the value of the keystroke based on the position in reference to the home key. Controller 430 may then process the value of the keystroke (e.g., the “1” key), or may forward the value of the keystroke to computer 104 (see FIG. 1) for processing.

The user may then return the finger to the home key, or may press additional locations (e.g., different keys) or the same location (e.g., the same key) to input additional information. Because keystrokes are determined based on the relative positions of a touch in reference to the home key, once the user establishes the home key, the user may enter an entire phone number on touch sensor pad 102 without returning their finger to the home key. This is advantageous, because the user may input information into electronic device 100 (see FIG. 1) without even looking at touch sensor pad 102. Rather, the user may establish the home key while applying a resting pressure to touch sensor pad 102, and then may simply move their finger relative to the home key position and apply a pressure for each keystroke above the keystroke threshold pressure without worrying about the exact coordinates of touch sensor pad 102 that their finger is striking.

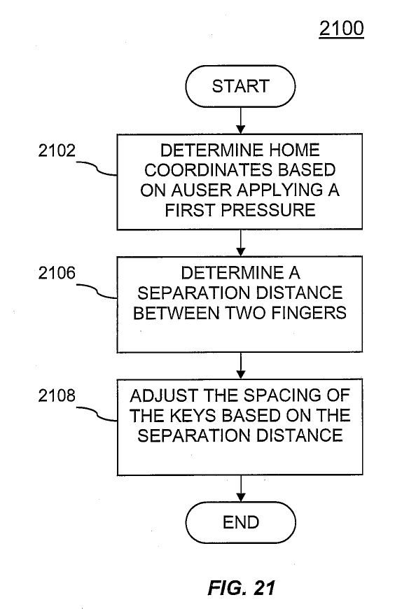

One advantage of touch sensor pad 102 is that the user can select the home position, and the position and spacing of the keys can adjust to the user's fingers or hands rather than forcing the user to adjust their fingers or hands to the position and spacing of the keys. FIG. 21 illustrates a method 2100 for determining the spacing and position of the keys of touch sensor pad 102 of FIG. 1 in an exemplary embodiment of the invention. The steps of method 2100 are described in reference to electronic device 100 and touch sensor pad 102 illustrated in FIGS. 1-2, 4-5 and 18-20. The steps of method 2100 may not be all-inclusive, and may include other steps not shown for the sake of brevity.

In step 2102, controller 430 determines a home position on touch sensor pad 102 responsive to a user applying a first pressure to touch sensor pad 102. The home position represents a base location from which the location of other touch points may be determined. For example, a user may initially rest their fingers on touch sensor pad 102, applying a first pressure at or below a resting threshold pressure.

The user may select any location of touch sensor pad 102 to establish the base location. Preferably, the user selects a base location which allows sufficient space for the layout of a keyboard. Thus, if the base location establishes the home row for touch-typing, then preferably the user does not select a base location which is adjacent to a top or bottom edge of touch sensor pad 102 and does not allow any regions of touch sensor pad 102 to capture keystrokes relating to rows of keys above or below the home key.

In step 2102, controller 430 determines home coordinates based on the selected base location. Controller 430 may determine the home coordinates by identifying two strips making physical contact responsive to the base location as described in reference FIG. 8. In step 2106, controller 430 determines a separation distance between two of the fingers of the user at the home positions of the fingers. For example, controller 430 may determine a difference between the home coordinates of two fingers to determine the separation distance.

In step 2108, controller 430 adjusts the spacing of the keys based on the separation distance. Thus, the spacing of the keys may be adjusted based the spacing between the user's finger. The spacing may also be adjusted based on an average distance between all of the fingers of one or both of the hands of the user. Further, controller 430 may determine a separation distance between each pair of adjacent fingers of the user, and then determine an average separation distance as a basis for adjusting the spacing of the keys.

One problem with traditional touch sensor pad input devices incorporated into a display of an electronic device (e.g., a touch screen) is the fact that a user's finger touching the touch sensor pad may occlude portions of the display. Thus, the user may be unable to view information displayed on the touch sensor screen as they apply input to the electronic device. If a display is incorporated on a front surface of an electronic device, then touch sensor pad 102 of FIG. 1 may be incorporated onto an opposing back surface of the electronic device such that the electronic device may mirror input applied to touch sensor pad 102 onto the display. Advantageously, the display is not occluded while the user applies input to the electronic device.

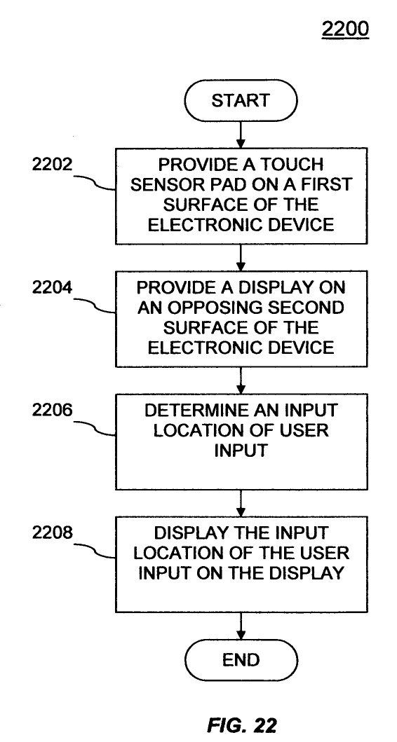

FIG. 22 illustrates a method 2200 for determining user input to an electronic device in an exemplary embodiment of the invention. The steps of method 2200 are described in reference to electronic device 100 and touch sensor pad 102 illustrated in FIGS. 1-2, 4-5 and 23-24. The steps of method 2200 may not be all-inclusive, and may include other steps not shown for the sake of brevity.

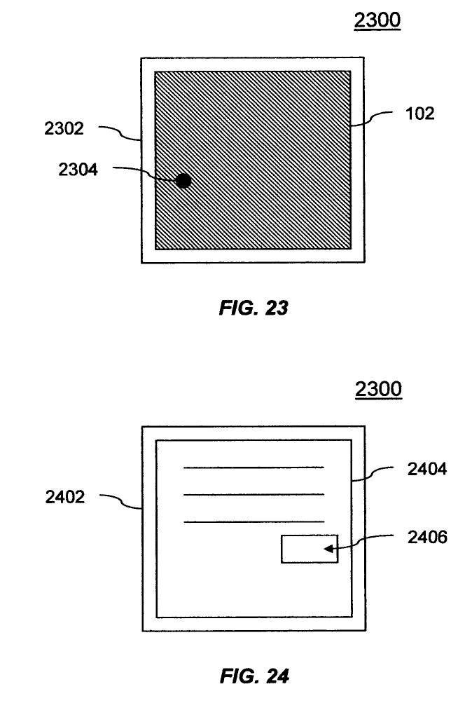

Step 2202 comprises providing touch sensor pad 102 on a first surface of an electronic device (e.g., a back surface of the electronic device). FIG. 23 illustrates an electronic device 2300 incorporating touch sensor pad 102 of FIG. 1 on a back surface 2302 of electronic device 2300 in an exemplary embodiment of the invention.

Step 2204 comprises providing a display on an opposing second surface of electronic device 2300 (e.g., a front surface of electronic device 2300). FIG. 24 illustrates the electronic device 2300 of FIG. 23 incorporating a display 2404 on a front surface 2402 of electronic device 2300 in an exemplary embodiment of the invention. Display 2404 may then image input applied to touch sensor pad 102 (see FIG. 23), providing the user with an un-occluded view of the display during the user input process.

In step 2206, controller 430 (see FIG. 4) of touch sensor pad 102 determines an input location of the user input applied to touch sensor pad 102. Assume, for example that the user input comprises moving a cursor (e.g., similar to moving a mouse), and that the user touches touch sensor pad 102 at input location 2304 (see FIG. 23). Controller 430 may then determine the input location as described above in reference to FIG. 8. If the user simultaneously touches touch sensor pad 102 at multiple locations, then controller 430 may determine multiple input locations. Touch sensor pad 102 may also function as a mouse, and pressure measurements of input location 2304 may be used to determine whether to process a mouse click. For example, a mouse click may be processed only if the pressured applied as input location 2304 is above a mouse click threshold pressure or keystroke threshold pressure.

In step 2208, controller 430 displays the input location of the user input on display 2404 (see FIG. 24). For example, if the input location corresponds to moving a cursor, then cursor 2406 may appear on display 2404. If user 2406 moves their finger along touch sensor pad 102, then the location of cursor 2406 on display 2404 will change to correspond to the position of the new input location of the finger on touch sensor pad 102. If there are multiple input locations, then controller 430 may display the multiple input locations on display 2404.

Touch sensor pad 102 of FIG. 1 may be adapted to determine pressure information regarding a touch (e.g., a keystroke) as described above in reference to FIG. 13. This pressure information may be used to determine an action to perform for a keystroke based on the pressure applied by the user to touch sensor pad 102. For example, computer 104 (see FIG. 1) may process only keystrokes that exceed a specified threshold pressure applied to touch sensor pad 102.

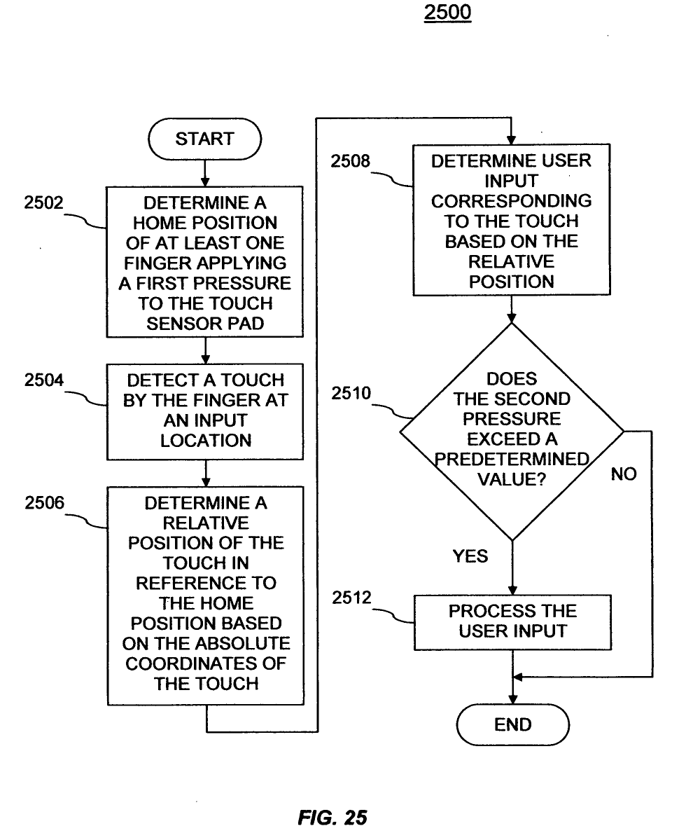

FIG. 25 illustrates a method 2500 for determining an action to perform for a keystroke based on a pressure applied to touch sensor pad 102 of FIG. 1 by a keystroke in an exemplary embodiment of the invention. The steps of method 2500 are described in reference to electronic device 100 and touch sensor pad 102 illustrated in FIGS. 1-2 and 4-5. The steps of method 2500 may not be all-inclusive, and may include other steps not shown for the sake of brevity.

In step 2502, controller 430 determines a home position of at least one finger applying a first pressure (e.g., greater than a resting threshold pressure) to touch sensor pad 102 (see FIG. 1). Controller 430 may determine the home position as described above in reference to FIG. 8 In step 2504, controller 430 detects a touch by the finger at an input location.

In step 2506, controller 430 determines a relative position of the touch at the input location in reference to the home position. To determine the relative position, controller 430 may determine absolute coordinates of the touch as described above in reference to FIG. 8. The absolute coordinates may be used to determine relative coordinates of the touch in reference to the home position. The relative coordinates then define the relative position of the touch. In step 2508, controller 430 determines user input corresponding to the touch based on the relative position.

In step 2510, controller 430 determines whether a second pressure applied to touch sensor pad 102 by the touch at the input location exceeds a predetermined pressure. Controller 430 may make the pressure determination as described above in reference to FIG. 13. The predetermined pressure may be a keystroke threshold pressure that is greater than a resting threshold pressure of a finger. The keystroke threshold pressure may be statically defined in controller 530, or may be determined based on the resting threshold pressure. If the pressure of the touch exceeds the predetermined pressure, then processing continues at step 2512. Otherwise, if the pressure of the touch does not exceed the predetermined pressure, then controller 430 may ignore the keystroke (or take a different action than provided in step 2510), and processing of method 2500 is completed.

In step 2512, controller 430 processes the value of the user input. For example, controller 430 may display the value of the user input on display 106 (see FIG. 1) of electronic device 100, or may provide the value of the user input to a processor (not shown) of computer 104 for further processing and translation.

Many people are hunt and peck typists that don't know the correct location of each key without looking at the keyboard. Instead, this type of user looks at the keyboard each time they want to enter a character, and locates the corresponding key for the character. Since touch sensor pad 102 of FIG. 1 may not be labeled with individual key markings, these users may not be aware of the location of their fingers with respect to specific keys. Touch sensor pad 102 may be adapted to provide visual cues to the user regarding the location of their fingers with respect to keys of the keyboard.

One advantage of measuring the pressure of a touch is that touch sensor pad 102 may differentiate between users moving their fingers around to locate a particular key and users applying a particular key as input to touch sensor pad 102. Advantageously, controller 430 may provide visual cues to a user as to the location of their finger when the user applies a relatively low pressure (e.g., a resting or searching threshold pressure) to touch sensor pad 102, and may process a touch as a keystroke when the user applies a relatively higher pressure (e.g., above a keystroke threshold pressure) to touch sensor pad 102.

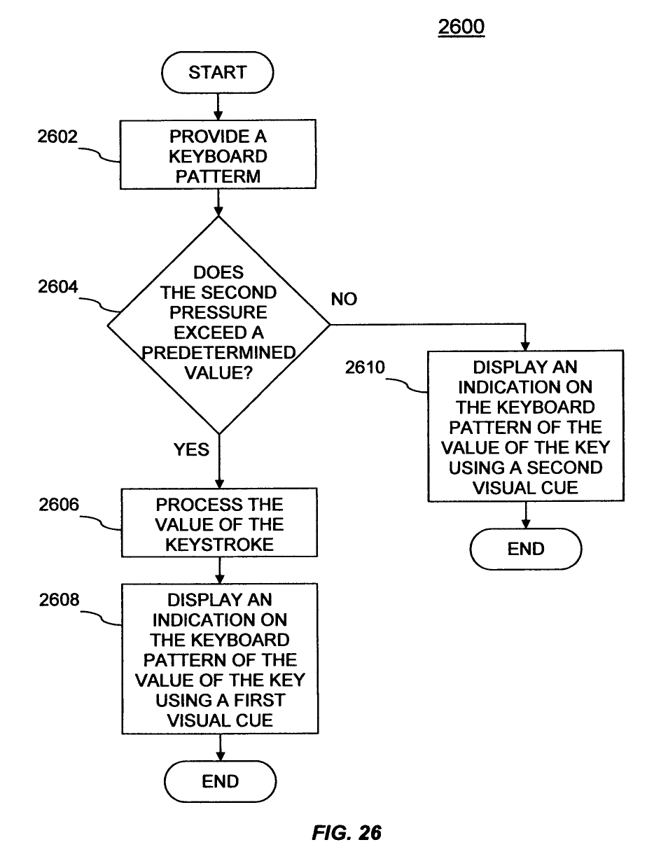

FIG. 26 illustrates a method 2600 for providing visual cues to a user regarding a location of a touch based on a pressure applied by the touch to touch sensor pad 102 of FIG. 1 in an exemplary embodiment of the invention. The steps of method 2600 are described in reference to electronic device 100 and touch sensor pad 102 illustrated in FIGS. 1-2 and 4-5. The steps of method 2600 may not be all-inclusive, and may include other steps not shown for the sake of brevity.

Step 2602 comprises providing a keyboard pattern on a display 106 of electronic device 100 (see FIG. 1). For example, controller 430 may display a QWERTY keyboard, such as FIG. 3, in a lower portion of display 106 (see FIG. 1). The keyboard pattern may further display visual cues to the user regarding the initial home positions of the user's fingers. For example, if the position of the user's fingers correspond to the home row keys (e.g., the “A”, “S”, “D”, “F”, “J”, “K”, “L”, and “:” keys, then controller 430 may display these keys in a particular color (e.g., grey) to indicate the home position of the fingers.

In step 2604, responsive to a keystroke, controller 430 determines whether a pressure applied by the keystroke to touch sensor pad 102 exceeds a predetermined value. The predetermined value represents a keystroke threshold pressure indicating that the touch is to be interpreted as a keystroke. Controller 430 may interpret touches applying a pressure below the threshold value as attempts by the user to locate a particular key. Controller 430 may make the pressure determination as described above in reference to FIG. 13.

If the pressure applied by the keystroke to touch sensor pad 102 exceeds the predetermined value, then processing continues in step 2606. In step 2606, controller 430 processes the value of the keystroke. In step 2608, controller 430 provides a visual cue to the user on display 106 (see FIG. 1) indicating that the value of the keystroke was processed by electronic device 100. The visual cue may comprise changing the color of the processed key on the keyboard pattern. The new color of the processed key may be different than the color used to indicate the home positions of the fingers. For example, assume that the user moves their middle finger from the “D” key to the “E” key. The color of the “D” key on the keyboard pattern may be changed to a base color of the keys (e.g., white), indicating that the middle finger is no longer located over the “D” key. The color of the “E” key on the keyboard pattern may be changed from white to green to indicate that the keystroke was processed by controller 430. Once the user returns their middle finger to the “D” key, the color of the “D” key on the keyboard pattern may be returned to grey, and the color of the “E” key may be changed back to white.

If the pressure applied by the keystroke to touch sensor pad 102 does not exceed the predetermined value, then processing continues in step 2610. In step 2610, controller 430 provides a visual cue to the user on display 106 (see FIG. 1) indicating the particular key where their finger is located. The visual cue may comprise changing the color of the key on the keyboard pattern. The new color of the key may be different than the colors used to indicate the home positions of the fingers and/or processed keys. For example, assume that the user moves their middle finger from the “D” key to the “E” key. The color of the “D” key on the keyboard pattern may be changed to the base color (e.g., white). The color of the “E” key on the keyboard pattern may be changed from white to yellow to indicate the location of the user's finger. Once the moves their finger from the “E” key, the color may return to the base color.

If the user subsequently applies a greater pressure to that location of touch sensor pad 102 (e.g., a pressure exceeding) the predetermined value, then controller 430 may process the value of the keystroke and display a visual cue indicating successful processing of the keystroke as described in steps 2606 and 2608. A user may locate a particular key without controller 430 processing the value of that keystroke, and then subsequently decide to input the value of that key by applying a relatively greater pressure to that location of touch sensor pad 102.

As previously described, touch sensor pad 102 may be incorporated onto a back surface of an electronic device to provide a keyboard on a surface opposite a display of the electronic device. Previously, the back surfaces of many electronic devices, such as laptops, tablet PCs, mobile telephone, etc., were unutilized or underutilized with respect to the placement of user input devices. Instead, user input devices were placed on the front surface of an electronic device with a display, resulting in a relatively larger electronic device, or relatively smaller user input devices and displays which are difficult for many users to utilize.

However, touch sensor pad 102 may be incorporated onto a back surface of an electronic device to provide a keyboard and other user input devices that utilize this previously unutilized surface area of the electronic device. Further, touch sensor pad 102 may be utilized as a keyboard while the user holds the device between one or more hands. Because touch sensor pad 102 can adjust the spacing and position of the keys of a keyboard based on home positions of the fingers, touch sensor pad 102 may adapt to the gripping locations of any user of an electronic device. Advantageously, a user can adjust their hands to any desired position, and type while holding the device between their hands.

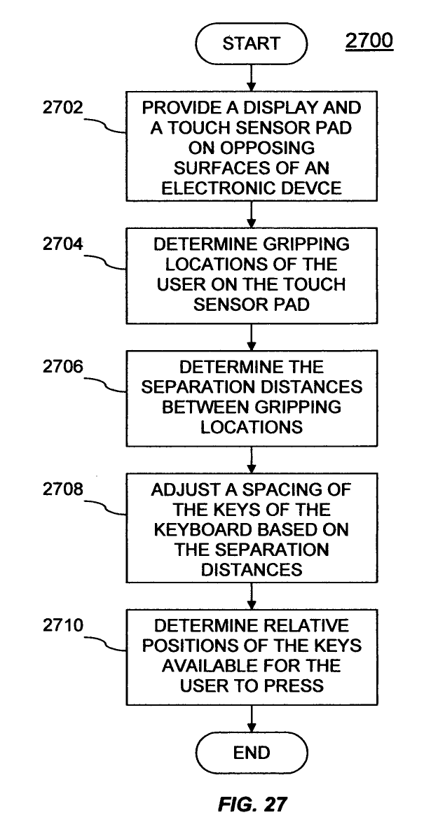

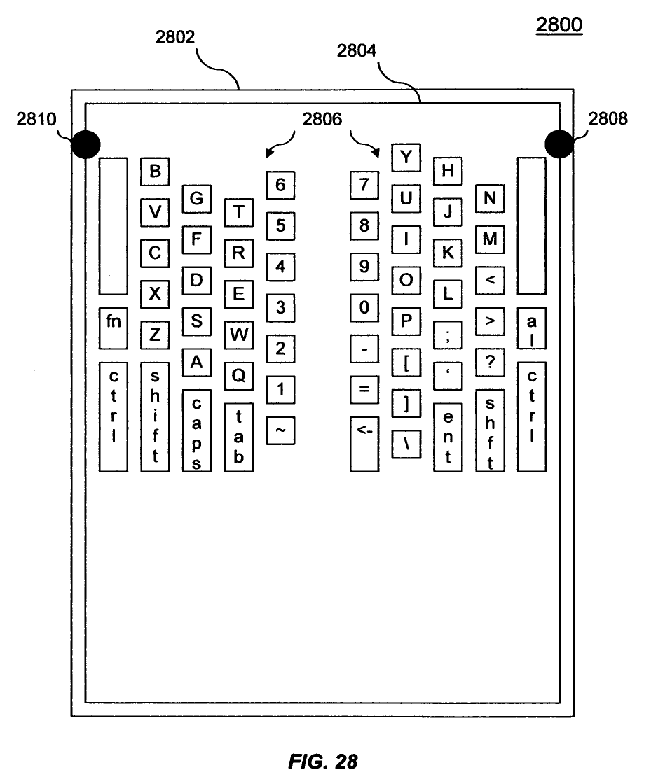

FIG. 27 illustrates a method 2700 for incorporating a touch sensor keyboard on a back surface of an electronic device in an exemplary embodiment of the invention. The steps of method 2700 are described in reference to electronic device 2800 illustrated in FIGS. 28-30. The steps of method 2700 may not be all-inclusive, and may include other steps not shown for the sake of brevity.

Step 2702 comprises providing a display and a touch sensor pad on opposing surfaces of an electronic device. FIG. 28 illustrates a front surface 2802 of an electronic device 2800 in an exemplary embodiment of the invention. Front surface 2802 of electronic device 2800 comprises a display 2804 including a keyboard pattern 2806. Keyboard pattern 2806 is illustrated as a QWERTY keyboard. However, those of ordinary skill in the art will recognize that any keyboard or keypad layout may utilized by electronic device 2800. A user (not shown) grips front surface 2802 of electronic device 2800 with their thumbs at gripping locations 2808 and 2810.

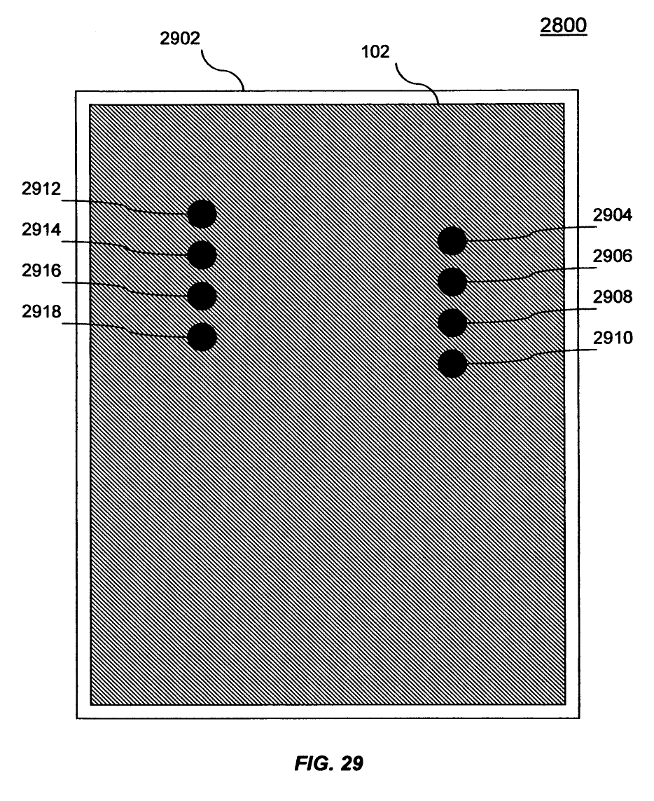

FIG. 29 illustrates a back surface 2902 of electronic device 2800 of FIG. 28 in an exemplary embodiment of the invention. Back surface 2902 of electronic device 2800 comprises a touch sensor pad 102. The area of touch sensor pad 102 may be selected based on desired design criteria. Preferably, touch sensor pad 102 is large enough to provide enough surface area to allow a user to grip touch sensor pad 102 with eight fingers. Preferably, touch sensor pad 102 is also large enough to provide enough surface area to provide each finger of the user a freedom of movement to touch locations of touch sensor pad 102 which may correspond to the keys of the keyboard. The user holds touch sensor pad 102 with their eight fingers at gripping locations 2904-2918.

In step 2704, controller 430 (see FIG. 4) determines gripping locations 2904-2918 of the user on touch sensor pad 102. Gripping locations 2904-2918 may represent the home positions (e.g., the home row keys) of the eight fingers. For example, gripping location 2904 may correspond to an “F” key of a QWERTY keyboard, and gripping location 2912 may correspond to a “J” key of the keyboard. In step 2706, controller 430 determines the separation distances between gripping locations 2904-2918.

In step 2708, controller 430 adjusts a spacing of the keys based on the separation distances determined in step 2706. In step 2710, controller 430 determines relative positions of the keys available for the user to press based on the gripping locations 2904-2918 and the separation distances between the gripping locations. In one embodiment, the keys available for the user to press may correspond to the keys of a QWERTY keyboard. The QWERTY keyboard may be approximately cut in half and rotated ninety degrees, such that the left side of touch sensor pad 102 corresponds to the left side of the QWERTY keyboard and the right side of touch sensor pad 102 corresponds to the right side of the QWERTY keyboard.

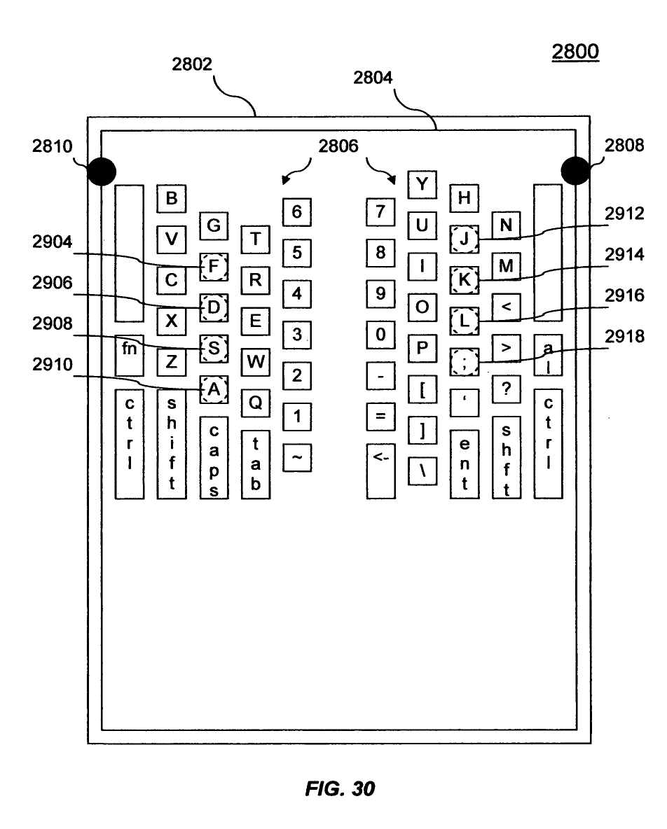

FIG. 30 illustrates the positions of the user's finger relative to keys displayed by the display 2804 of the electronic device of FIG. 28 in an exemplary embodiment of the invention. Each gripping location 2904-2918 may correspond to a key of keyboard pattern 2808. The corresponding key on keyboard pattern 2806 for each gripping location 2904-2918 may be colored or include some other visual cue which indicates the locations of the user's fingers on back surface 2902 of electronic device 2802. Because of the visual cues displayed on keyboard pattern 2806, the user is in effect looking through electronic device 2800 and viewing their fingers on back surface 2902.

Keystrokes may be determined as described above in reference to FIG. 14 based on relative directions of movements from gripping locations 2904-2918. For example, if a user moves their left index finger in a direction up from gripping location 2904, then the keystroke may correspond to a “G” key. Relative pressures of touches by each finger on touch sensor pad 102 as described above in reference to FIG. 13 may be used to determine whether the user intends to input a particular character, or whether the user is attempting to locate their finger over a particular key. Visual cues as described in FIG. 26 may be displayed on keyboard pattern 2806 based on the relative positions and pressures applied by each finger. For example, if a user moves their index finger in a direction up from gripping location 2904 and applies a pressure that does not exceed the keystroke threshold pressure, then the “G” key on keyboard pattern 2806 may be changed from white to yellow. Likewise, if the pressure of the keystroke exceeds the keystroke threshold, then the “G” key on keyboard pattern 2806 may be changed from white to green, indicating input of the “G” character.

Advantageously, a user may utilize electronic device 2800 without the need to view the position of their fingers. Touch-typists may establish the home row position of their fingers and begin typing as they normally would on a mechanical keyboard. The relative position of the user's keystrokes will be translated to the value of each individual keystroke and processed by electronic device 2800.

Hunt and peck typists may also utilize electronic device 2800, and may simply move their fingers around touch sensor pad 102 and to locate a particular key. Once a visual cue on keyboard pattern 2806 indicates to the user that they have located the correct key, they may apply a pressure exceeding the keystroke threshold value to input the value of the key as they normally would on a mechanical keyboard.

Touch sensor pad 102 may also be utilized to capture other user input such as handwriting, drawings, mouse clicks, etc. Advantageously, users may apply input to electronic device 2800 without occluding display 2804. Further, because a user input device no longer consumes portions of front surface 2802 of electronic device 2800, a display 2804 may be relatively larger than displays utilized previously in many electronic devices to construct the same size electronic device.

Although specific embodiments were described herein, the scope of the invention is not limited to those specific embodiments. The scope of the invention is defined by the following claims and any equivalents therein.

I claim:

1. A method for determining input of a touch sensor pad by a plurality of fingers of a user, the method comprising:
determining a home position on the touch sensor pad responsive to the plurality of fingers applying a first pressure to the touch sensor pad;
detecting a keystroke on the touch sensor pad responsive to a finger applying a second pressure to the touch sensor pad;
determining a relative position of the keystroke in reference to the home position of the finger responsive to detecting the keystroke; and
determining a value of the keystroke based on the relative position.

2. The method of claim 1, wherein the step of determining the value of the keystroke further comprises:
determining whether the second pressure applied by the keystroke exceeds a predetermined value; and
processing the value of the keystroke responsive to determining that the second pressure exceeds the predetermined value.

3. The method of claim 2, further comprising:
displaying a keyboard pattern to the user, wherein the keystroke corresponds to a key of the keyboard pattern; and
displaying a first visual cue on the key of the keyboard pattern indicating the relative position of the keystroke responsive to determining that the second pressure does not exceed the predetermined value.

4. The method of claim 3, further comprising:
displaying a second visual cue on the key of the keyboard pattern indicating that the keystroke was processed responsive to determining that the second pressure exceeds the predetermined value.

5. The method of claim 1, wherein the touch sensor pad is incorporated into an electronic device, and the step of determining the home position further comprises:
determining gripping locations on the touch sensor pad where the user is gripping the electronic device with at least one hand including the fingers; and
determining the home position of the fingers based on the gripping locations of the at least one hand of the user.

6. The method of claim 5, wherein the electronic device includes a display disposed on a first surface of the electronic device, and the touch sensor pad is disposed on an opposing second surface of the electronic device.

7. The method of claim 1 further comprising:
providing the touch sensor pad, the touch sensor pad including a first plurality of resistive sensor strips on a first resistive sheet and a second plurality of resistive sensor strips on a second resistive sheet, and
wherein the step of determining the home positions of each of the plurality of fingers further comprises:
identifying a first strip of the first plurality of resistive sensor strips of the first resistive sheet that is physically contacting a second strip of the second plurality of resistive sensor strips of the second resistive sheet responsive to a finger touching the touch sensor pad at the home position;
identifying the second strip;
measuring a first voltage of the second strip applied by the first strip while in contact with the second strip responsive to the finger touching the touch sensor pad at the home position;
measuring a second voltage of the first strip applied by the second strip while in contact with the first strip responsive to the finger touching the touch sensor pad at the home position; and
determining home coordinates of the home position based on the first voltage and the second voltage.

8. The method of claim 7, wherein the step of determining the relative position of the keystroke further comprises:
identifying a third strip of the first plurality of resistive sensor strips of the first resistive sheet that is physically contacting a fourth strip of the second plurality of resistive sensor strips of the second resistive sheet responsive to the keystroke;
identifying the fourth strip;
measuring a third voltage of the fourth strip applied by the third strip while in contact with the fourth strip responsive to the keystroke;
measuring a fourth voltage of the third strip applied by the fourth strip while in contact with the third strip responsive to the keystroke;
determining absolute coordinates of the keystroke based on the third voltage and the fourth voltage; and
determining the relative position of the keystroke in reference to the home coordinates based on the absolute coordinates of the keystroke.

9. The method of claim 8, wherein the third strip has a base resistance and the step of measuring the second pressure further comprises:
measuring a measured resistance of the third strip during contact between the third strip and the fourth strip responsive to the keystroke; and
determining the second pressure based on a difference between the measured resistance and the base resistance.

10. The method of claim 7, wherein the step of determining the associated home position of the selected fingers further comprises:
determining a separation distance between the selected finger and another of the plurality of fingers based on the home positions of the plurality of fingers; and
adjusting a spacing of the keys of the keyboard based on the separation distance between the selected finger and the other of the plurality of fingers.

11. The method of claim 1, wherein the first pressure is less than a keystroke threshold pressure.

12. The method of claim 1, wherein the second pressure is greater than a keystroke threshold pressure.

13. The method of claim 1 wherein the touch corresponds to a cursor of the display and the step of processing the user input further comprises:
moving the cursor on the display responsive to the user moving the at least one finger on the touch sensor pad.

14. The method of claim 13 wherein the touch corresponds to a mouse click by the user and the step of processing the user input further comprises:
processing the mouse click responsive to determining that the second pressure exceeds the predetermined value.

15. The method of claim 4, wherein keys available for the user to touch on the touch sensor pad are keys of a QWERTY keyboard.

16. The method of claim 4, wherein keys available for the to user touch on the touch sensor pad are keys of a mobile telephone keypad.

17. An apparatus for determining input of a touch sensor pad by a finger of a user, the apparatus comprising:
a touch sensor pad; and
a controller coupled to the touch sensor pad, the controller adapted to:
determine a home position on the touch sensor pad responsive to a plurality of fingers applying a first pressure to the touch sensor pad;
detect a keystroke on the touch sensor pad responsive to a finger applying a second pressure to the touch sensor pad;
determine a relative position of the keystroke in reference to the home position of the finger responsive to detecting the keystroke; and
determine a value of the keystroke based on the relative position.

18. The apparatus of claim 17, wherein the controller is further adapted to:
determine whether the second pressure applied by the keystroke exceeds a predetermined value; and
process the value of the keystroke responsive to determining that the second pressure exceeds the predetermined value.

19. The apparatus of claim 18, wherein the controller is further adapted to:
display a keyboard pattern to the user, wherein the keystroke corresponds to a key of the keyboard pattern; and
display a first visual cue on the key of the keyboard pattern indicating the relative position of the keystroke responsive to determining that the second pressure does not exceed the predetermined value.

20. The apparatus of claim 19, wherein the controller is further adapted to:
display a second visual cue on the key of the keyboard pattern indicating that the keystroke was processed responsive to determining that the second pressure exceeds the predetermined value.

21. The apparatus of claim 17, wherein the touch sensor pad is incorporated into an electronic device, and the controller is further adapted to:
determine gripping locations on the touch sensor pad where the user is gripping the electronic device with at least one hand including the fingers; and
determine the home position of the finger based on the gripping locations of the at least one hand of the user.

22. The apparatus of claim 21, wherein the electronic device includes a display disposed on a first surface of the electronic device, and the touch sensor pad is disposed on an opposing second surface of the electronic device.

23. The apparatus of claim 17, wherein the touch sensor pad further comprises:
a first resistive sheet with a first plurality of resistive sensor strips; and
a second resistive sheet with a second plurality of resistive sensor strips.

24. The apparatus of claim 23, wherein the controller is further adapted to:
identify a first strip of the first plurality of resistive sensor strips of the first resistive sheet that is physically contacting a second strip of the second plurality of resistive sensor strips of the second resistive sheet responsive to each of the fingers touching the touch sensor pad at the home positions;
identify the second strip;
measure a first voltage of the second strip applied by the first strip while in contact with the second strip responsive to the finger touching the touch sensor pad at the home position;
measure a second voltage of the first strip applied by the second strip while in contact with the first strip responsive to the finger touching the touch sensor pad at the home position; and
determine home coordinates of the home position based on the first voltage and the second voltage.

25. The apparatus of claim 24, wherein the controller is further adapted to:
identify a third strip of the first plurality of resistive sensor strips of the first resistive sheet that is physically contacting a fourth strip of the second plurality of resistive sensor strips of the second resistive sheet responsive to the keystroke;
identify the fourth strip;
measure a third voltage of the fourth strip applied by the third strip while in contact with the fourth strip responsive to the keystroke;
measure a fourth voltage of the third strip applied by the fourth strip while in contact with the third strip responsive to the keystroke;
determine absolute coordinates of the keystroke based on the third voltage and the fourth voltage; and
determine the relative position of the keystroke in reference to the home coordinates based on the absolute coordinates of the keystroke.

26. The electronic device of claim 25, wherein the third strip has a base resistance and the controller is further adapted to:
measure a measured resistance of the third strip during contact between the third strip and the fourth strip responsive to the keystroke; and
determine the second pressure based on a difference between the measured resistance and the base resistance.

27. The electronic device of claim 25, wherein the controller is further adapted to:
determine a separation distance between the selected finger and another of the plurality of fingers based on the home positions of the plurality of fingers; and
adjust a spacing of the keys of the keyboard based on the separation distance between the selected finger and the other of the plurality of fingers.

28. The apparatus of claim 17, wherein the first pressure is less than a keystroke threshold pressure.

29. The apparatus of claim 17, wherein the second pressure is greater than a keystroke threshold pressure.

30. The electronic device of claim 17, wherein the touch corresponds to a cursor of the display and the controller is further adapted to move the cursor on the display responsive to the user moving the at least one finger on the touch sensor pad.

31. The electronic device of claim 30, wherein the touch corresponds to a mouse click by the user and the controller is further adapted to process the mouse click responsive to determining that the second pressure exceeds the predetermined value.

32. The electronic device of claim 20, wherein keys available for the user to touch on the touch sensor pad are keys of a QWERTY keyboard. 33. The electronic device of claim 20, wherein keys available for the user to touch on the touch sensor pad are keys of a mobile telephone keypad.
